(19) United States
(12) Patent Application Publication
(10) Pub. No.: US 2018/0241814 A1
(43) Pub. Date: Aug. 23, 2018

(54) A System, a Node, a Method in a Communication Network and a Computer Program and Corresponding Computer Program Product

(71) Applicant: Telefonaktiebolaget LM Ericsson (publ), Stockholm (SE)

(72) Inventors: Johan Kristiansson, Luleå (SE); Andreas Hägglund, Luleå (SE)

(21) Appl. No.: 15/546,114

(22) PCT Filed: Feb. 6, 2015
(86) PCT No.: PCT/EP2015/052491

§ 371 Date: Jul. 25, 2017

(51) Int. Cl. H04L 29/08

(52) U.S. Cl. CPC H04L 67/1065; H04L 67/1072

(57) ABSTRACT

An object of the present invention is to develop scalable and decentralized cloud platforms. That is achieved by introducing geographical process look-up. In this specification, geographical process lookup implies finding a running software process running a runtime environment associated with a geographical location. This process can also be used to find a runtime environment to deploy a new (software) process. According to embodiments of the present invention geographical process lookup is accomplished by combining geohash and Kademlia's ability to find nodes that are close to each other and by introducing special software agents so called process runtime agents, which are responsible for managing (e.g. deploying/starting) software processes. Geographical process lookup is then achieved according to embodiments by storing references to the process runtime agents in the DHT as key-values, with the key being the agent's geohash string generated from their geographic latitude and longitude coordinates, and the value being other information e.g. how to connect to the agent.

### TECHNICAL FIELD

The present invention relates to a system, a node, a method in a communication network and a computer program and corresponding computer program product.

A process P is running on a first node associated with a first process runtime agent in a first geographical location which is identified by a geohash string and a process runtime agent that is geographically close to the first geographical location is identified.

### BACKGROUND

Cloud computing is a model for enabling ubiquitous, convenient, on-demand network access to a shared pool of configurable computing resources that can be rapidly provisioned and released with minimal management effort or service provider interaction. Examples of such services are cloud storage and cloud computing that make it possible for the users to store documents, photos, music etc. for download on its user devices and also to share the documents, photos and music etc. with other users.

Cloud platforms allow cloud management and developers to write applications that run in the cloud, or to use services provided from the cloud, or both. Different names are used for this kind of platform, including on-demand platform and platform as a service (PaaS).

The use of cloud-based platforms in the industry is increasing and therefore there is a need to develop scalable and decentralized cloud platforms. Such platforms would make it possible to easily manage and deploy cloud services, e.g. telecommunication equipment such as radio base stations or new media and communication services.

A cloud service has three distinct characteristics that differentiate it from traditional hosting. It is sold on demand, typically by minute or the hour; it is elastic, which means that a user can utilize a service, as they want at any given time; and the service is fully managed by the provider. The consumer needs nothing except a personal computer connected to the Internet. Significant innovations in virtualization and distributed computing, as well as improved access to high-speed Internet have accelerated interest in cloud computing.

Further, assuming that there is a relationship between IP delay and geographical distance, for time critical real-time systems, it is desired that the servers and other components of the cloud platforms are deployed geographically close to the end-users. In addition, for other non real-time critical services it may also be desired to identify and deploy servers of the cloud platform geographically close to the end-users.

A hash table is a data structure used to implement an associative array, a structure that can map keys to values. A hash table uses a hash function to compute an index into an array of buckets or slots, from which the correct value can be found. The stored value can be accessed in O(1) time by directly looking up the key in the hashtable. O(1) describes an algorithm that will always execute in the same time (or space) regardless of the size of the input data set

A distributed hashtable (DHT) is a decentralized type of hash table, which stores key-value pairs in such a way that the responsibility of the mapping is distributed among the network nodes. A DHT can therefore be viewed as a distributed lookup protocol designed to locate a network node where a particular data object is stored.

Various DHT algorithms have been proposed over the years. One example is Kademlia which is a distributed hash table algorithm used for implementing decentralized peer-to-peer computer networks It is described in “Kademlia: A peer-to-peer information system based on the XOR Metric”, by Petar Maymounkov and David Mazi'eres, which could be found at http://pdos.csail.mitedu/˜petar/papers/maymounkov-kademlia-Incs.pdf. The following text describes Kademlia in more detail.

Kademlia specifies the structure of the network and the exchange of information through node lookups. Kademlia nodes communicate with themselves using UDP (User Datagram Protocol). A virtual or overlay network is formed by the participant nodes. Each node is identified by a number or node ID (identity). The node ID serves not only as identification, but the Kademlia algorithm uses the node ID to locate values (usually file hashes or keywords). In fact, the node ID provides a direct map to file hashes and the node identified by the node ID stores information on where to obtain the file or resource, referred to as values above.

When looking up a value, the algorithm needs to know the associated key and explores the network in several steps. Each step will find nodes that are closer to the key until the contacted node returns the value or indicates that no more closer nodes are found. This is very efficient. Like many other DHTs, the time it takes to find a specific value in Kademlia is only O(log(N), where N is the total number of nodes in the system. Note that dubbeling the number of nodes (2*N) in the network, does not dubble the search time in this case.

To locate nodes near a specific node identified with a node ID, Kademlia uses a binary tree-based routing algorithm. Hence, the nodes are leaves in a binary tree with each node's position determined by the shortest unique prefix of its node ID. As stated above, the lookup for a node is done in O(log(N)) steps by for each step done finding node IDs that are close to the searched node ID. FIG. 1 is showing a tree with Kademlia node IDs where the black node being the prefix 0011 and the circled areas are sub-trees which do not contain 0011. Every node in the Kademlia network knows of at least one node in each of their sub-trees. This makes it possible to guarantee that the binary tree-based routing algorithm can locate nodes by their node ID when searching the tree.

Geohash is a geocode system that converts a coordinate pair of latitude (lat) and longitude (long) into a string with a base32 character map (implying a symbol set made up of 32 different characters). This string will have different lengths depending on the desired hash precision. A geohash string with the length of 9 characters will give precision of around 2 meter while a precision of 1 character is basically 1/32th of the area of the earth. So each character added to the hash divides the rectangle denoted by the prefix into 32 smaller rectangles.

For example, by using the geohash.org webpage it is possible to use the hash string in the URL geohash.org/u7xtr giving us a marker at the coordinates (65.6, 22.1), which basically points at Luleå as a town at that precision. While if adding another four characters to the geohash Luleå University of Technology will be pinpointed with geohash.org/u7xtr9pzr at the coordinates (65.6171, 22.1374). Accordingly, geohash can be used as a way to uniquely identify a certain area.

To make this work, the encoding scheme got a slightly different order depending on if it's an odd or even level of the hash, wherein the level being the length of the hash. Table 1 is how odd levels are ordered and Table 2 is for the even levels. These tables are made using something called a z-curve, which is described in FIG. 2.

The decoding works like this, the geohash code ezs42 got the bit representation: 01101 11111 11000 00100 00010 taking the even bits as the longitude code and odd bits as latitude code. To get the decimal representation of the latitude and longitude from this bit string a divide and conquer algorithm is used for example when decoding the latitude value it can range between −90 and 90 and since the latitude bit string is 101111001001 the first bit will be inspected first, in this case it is 1 this means that the value searched for is in the range 0-90 now the second bit will be inspected being 0 for this case which means that the range will be reduced to 0-45. So when this is done for each bit in the string it will give a more and more precise position with 1's selecting the higher half of the range while 0's selects the lower.

### SUMMARY

An object of the present invention is to develop scalable and decentralized cloud platforms. That is achieved by introducing a geographical process lookup. In this specification, geographical process lookup implies finding a running software process running a runtime environment associated with a geographical location. This process can also be used to find a runtime environment to deploy a new (software) process.

According to embodiments of the present invention geographical process lookup is accomplished by combining geohash and Kademlia's ability to find nodes that are close to each other and by introducing special software agents so called process runtime agents, which are responsible for managing (e.g. deploying/starting) software processes. Geographical process lookup is then achieved according to embodiments by storing references to the process runtime agents in the DHT as key-values, with the key being the agent's geohash string generated from their geographic latitude and longitude coordinates, and the value being other information e.g. how to connect to the agent.

Thus, the idea of a decentralized cloud is developed further by the embodiments by making it possible to find, discover and deploy software processes based on geographical location. A software process in this case can either be a software process running in a software container, or a virtual machine, but also a software process running in an end-user device such as a smartphone or an IoT (Internet of things) device. A software container is a mechanism for enabling a software processes to be run in isolated user space instances provided by the kernel in an operation system.

According to a first aspect of embodiments of the present invention, a method performed in a communication network, wherein a process P is running on a first node associated with a first process runtime agent in a first geographical location is provided. The first geographical location is identified by a geohash string. In the method, the second node, associated with a second process runtime agent, receives a request of information of at least one process runtime agent geographically close to the first geographical location. Further, the second node enables representation of process runtime agents and their respective geohash string in a DHT, wherein the geohash string is indicative of a coordinate pair of latitude and longitude of the process runtime agent and the length of the string depends on the precision of the coordinate pair. The DHT is distributed over multiple geographical locations associated with a respective process runtime agent. The second node initiates a search for process runtime agents in geographical grids surrounding the first geographical location, using the DHT and the geohash strings, to identify a process runtime agent that is geographically close to the first geographical location.

According to a second aspect, a second node, associated with a second process runtime agent, of a communication network, wherein a process P is running on a first node associated with a first process runtime agent in a first geographical location is provided. The first geographical location is identified by a geohash string and the second node comprises a processor and a memory storing instructions that, when executed by the processor, causes the second node to: receive a request of information of at least one process runtime agent geographically close to the first geographical location and enable representation of process runtime agents and their respective geohash string in a DHT. The geohash string is indicative of a coordinate pair of latitude and longitude of the process runtime agent and the length of the string depends on the precision of the coordinate pair, and the DHT is distributed over multiple geographical locations associated with a respective process runtime agent. The instructions stored on the memory, when executed by the processor further causes the second node to initiate a search for process runtime agents in geographical grids surrounding the first geographical location, using the DHT and the geohash strings, to identify a process runtime agent that is geographically close to the first geographical location.

According to a third aspect a communication network comprising a second node, associated with a second process runtime agent, and a first node, associated with a first process runtime agent is provided. A process P is running on the first node in a first geographical location and wherein the first geographical location is identified by a geohash string. The first node comprising: a processor; and a memory storing instructions that, when executed by the processor, causes the first node to send a request of information of at least one process runtime agent geographically close to the first geographical location. The second node comprising: a processor; and a memory storing instructions that, when executed by the processor, causes the second node to receive a request of information of at least one process runtime agent geographically close to the first geographical location, enable representation of process runtime agents and their respective geohash string in a distributed hash table, DHT, wherein the geohash string is indicative of a coordinate pair of latitude and longitude of the process runtime agent and the length of the string depends on the precision of the coordinate pair. The DHT is distributed over multiple geographical locations associated with a respective process runtime agent. Further, instructions are also stored that, when executed by the processor, causes the second node to initiate a search for process runtime agents in geographical grids surrounding the first geographical location, using the DHT and the geohash strings, to identify a process runtime agent that is geographically close to the first geographical location.

A computer program for identifying a process runtime agent that is geographically close to a first geographical location is provided according to a fourth aspect. A process P is running on a first node associated with a first process runtime agent in the first geographical location and wherein the first geographical location is identified by a geohash string. The computer program comprising computer program code which, when run on a second node associated with a second process runtime agent, of a communication network, causes the second node to:
receive a request of information of at least one process runtime agent geographically close to the first geographical location,
enable representation of process runtime agents and their respective geohash string in a DHT wherein the geohash string is indicative of a coordinate pair of latitude and longitude of the process runtime agent and the length of the string depends on the precision of the coordinate pair, and wherein the DHT is distributed over multiple geographical locations associated with a respective process runtime agent, and to
initiate a search for process runtime agents in geographical grids surrounding the first geographical location, using the DHT and the geohash strings, to identify a process runtime agent that is geographically close to the first geographical location.

According to a fifth aspect, a computer program product comprising a computer program as mentioned above is provided and a computer readable means on which the computer program is stored.

According to a sixth aspect a second node, associated with a second process runtime agent, of a communication network is provided. A process P is running on a first node associated with a first process runtime agent in a first geographical location and wherein the first geographical location is identified by a geohash string. The second node comprising means for receiving a request of information of at least one process runtime agent geographically close to the first geographical location, means for enabling representation of process runtime agents and their respective geohash string in a DHT wherein the geohash string is indicative of a coordinate pair of latitude and longitude of the process runtime agent and the length of the string depends on the precision of the coordinate pair, and wherein the DHT is distributed over multiple geographical locations associated with a respective process runtime agent. The second node further comprises means for initiating a search for process runtime agents in geographical grids surrounding the first geographical location, using the DHT and the geohash strings, to identify a process runtime agent that is geographically close to the first geographical location.

Some embodiments of the invention make it possible to specify a range and search a geographically area for process runtime environment targets by performing so-called expand searches in a Distributed Hash Table (DHT). By using the DHT it becomes possible to create a distributed and decentralized platform without central control that are massively scalable, which is very different compared to today's cloud computing technology typically based on centralized solutions, e.g. centralized cloud orchestrations engines.

It is believed that at least some embodiments have make it possible to build a distributed IoT cloud platform. All kinds of devices and services in the future may be able to run software containers either virtually or physically. Today's cloud technology may fail to scale to support billions of devices, which would motivate the use of P2P infrastructure as in the embodiments described below.

### BRIEF DESCRIPTION OF THE DRAWINGS

FIG. 1 illustrates a Kademlia routing table according to prior art.

FIG. 2 illustrates geohash according to prior art.

FIG. 3 illustrates geo-process management of software containers according to embodiments of the present invention.

FIG. 4 is a flowchart showing an embodiment of the present invention.

FIG. 5 illustrates schematically process runtime agents according to embodiments of the present invention.

FIG. 6 is a flowchart showing an embodiment of the present invention.

FIG. 7a shows how a search with LayerExpand is done by starting in the center and then taking the first layer (blue) followed by the second layer (yellow).

FIG. 7b is a flowchart for LayerExpand showing how the search for a nearby Process Runtime Agent is done by the LayerExpand method.

FIG. 8a is showing how the SpiralBoxExpand this is done by starting in the center and moving north and west on odd number and south and east on even numbers.

FIGS. 8b-8c show test results of comparisons between LayerExpand and SpiralBoxExpand.

FIGS. 9a-9c illustrates different embodiments of the present invention.

FIG. 10 illustrates a communication network with multiple process runtime agents according to embodiments of the present invention.

FIG. 11 illustrates an embodiment of the present invention.

FIG. 12 illustrates an embodiment when implemented in a computer program product.

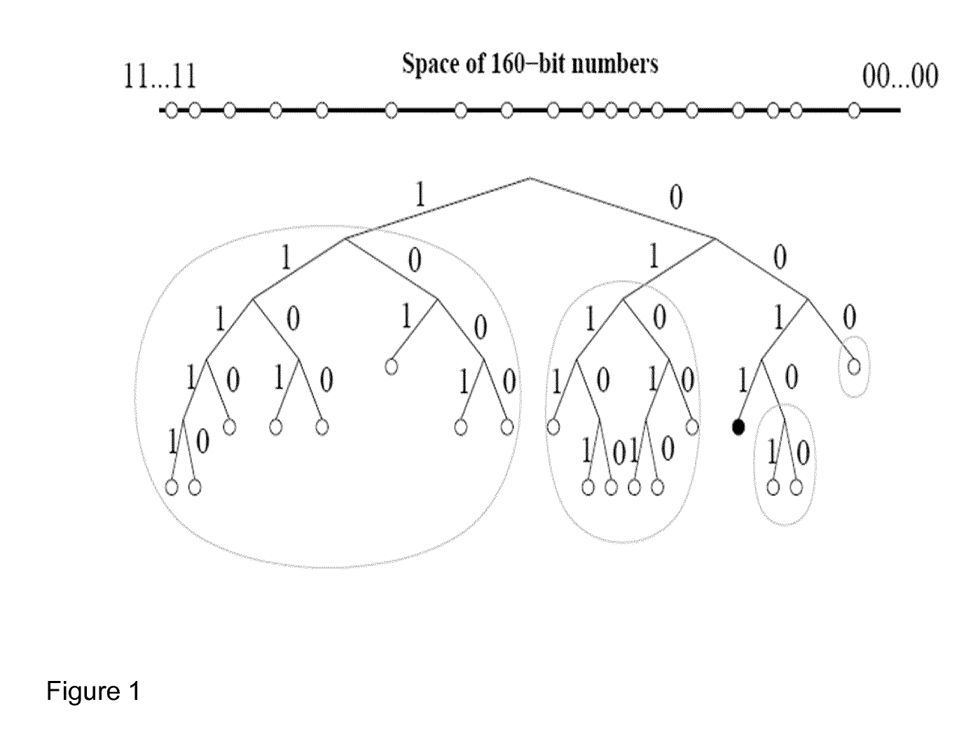

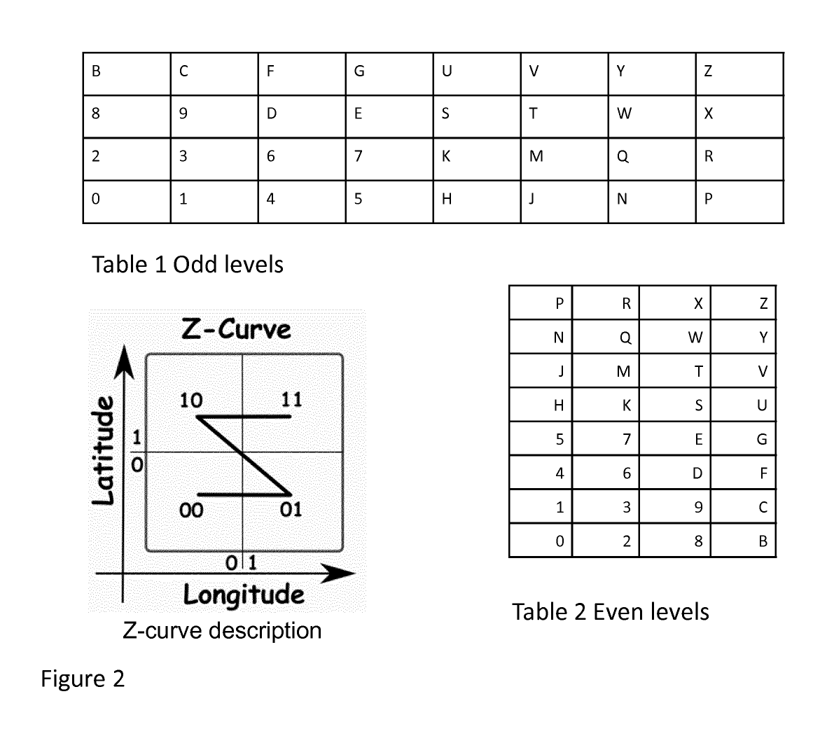

### DETAILED DESCRIPTION

According to the embodiments of the present invention, an agent is introduced, referred to as process runtime agent, which represents a process runtime environment. Examples of runtime environment are Docker engine described in http://www.linux.com/news/enterprise/cloud-computing/731454-docker-a-shipping-container-for-linux-code and Mesos described in http://mesos.berkeley.edu/mesos_tech_report.pdf. The agent is configured to publish the underlying process runtime environment's geographical position in a DHT. The process runtime agent can be described as an agent configured to be a part of the DHT and to provide information on how to connect to the process runtime environment for the application that was searched for or is going to be used to run the specific application.

In the prior art solutions it is only possible to lookup specific keys in a DHT and generally not possible for search for information, whereas the essence of the proposed solution is to represent geographical locations grids as keys in the DHT and use that structure to iterate and search for process runtime agents in surrounding grids, thus providing a search function albeit limited to the geographical location.

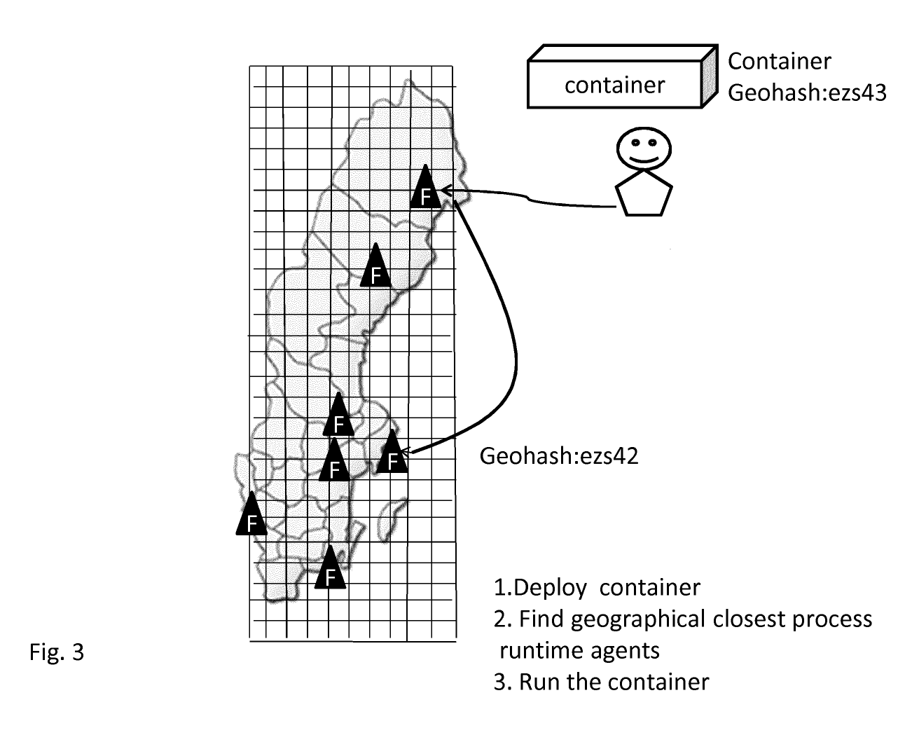

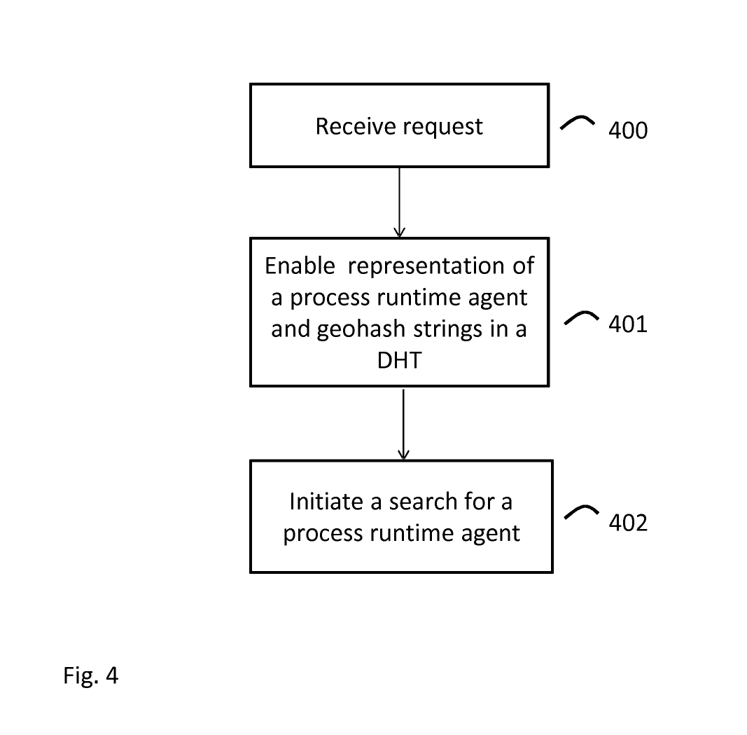

FIG. 3 illustrates how software containers can be deployed to a process runtime environment associated with a geographical area. In the example in FIG. 3, different process management runtimes are connected to a P2P network, and when a developer (or software component) deploys a container, the proposed search function is able to find the geographical closest process runtime environment registered in the DHT based on a geo-tag set on the container. The F symbol in FIG. 4 represents process runtime environments available in the DHT which is a P2P (peer-to peer) network.

Meta data, such as IP-address, geographic location (latitude, longitude), MAC address, port information, about process runtime agents are stored in the DHT with the key being a geohash string and the value a set of meta data of process runtime agents registered at the geographical location indicated by the geohash string. This makes it possible to search for agents by looking up the geometa data in the DHT and use an expand search algorithm to find geographical nearby agents. The solution is thus distributed and decentralized as well as scalable system (assuming a large geographical area is not searched), where the DHT can be used for registering, and finding the nearest process runtime agents. According to embodiments of the present invention different expand search functions can be used.

Accordingly, a method performed in a communication network, wherein a process P is running on a first node associated with a first process runtime agent in a first geographical location is provided as illustrated in FIG. 4. The first geographical location is identified by a geohash string. The second node, associated with a second process runtime agent, receives 400 a request of information of at least one process runtime agent geographically close to the first geographical location. Further, the second node enables 401 representation of process runtime agents and their respective geohash string in a DHT, wherein the geohash string is indicative of a coordinate pair of latitude and longitude of the process runtime agent and the length of the string depends on the precision of the coordinate pair. The DHT is distributed over multiple geographical locations associated with a respective process runtime agent. The second node initiates 402 a search for process runtime agents in geographical grids surrounding the first geographical location, using the DHT and the geohash strings, to identify a process runtime agent that is geographically close to the first geographical location.

According to one embodiment, a key/value pair of the DHT comprises the geohash string representing the geographical location of the process runtime agent as the key and identity meta information (e.g. IP-number or other connection related information) of the process runtime agent as the value of the DHT.

The following two examples illustrate in more detail the role of the process runtime agent and how it is used to perform geographical process lookup.

One example could be to find video conference equipment (e.g. monitor, projector, drawing, connected drawing boards etc.) at a specific location to set up a video conference meeting. In this case, video conference equipment runs a software process that is connected to a process runtime agent. The software process could for example connect a video stream to a monitor/computer.

Typically, when the conference equipment is started it determines it geographical location (e.g. using an indoor location system) and then locates the closest process runtime agent responsible for the geographical area that includes the determined geographical location. The process runtime agent could run directly on the conference equipment, but it could also run remotely in a datacenter somewhere. In both cases, the process runtime agent is associated with a specific geographical location.

When a user enters the conference room, it can thus use the proposed geo process lookup scheme to connect to process runtime agent responsible for the conference equipment.

Another example could be an intelligent transport system where the embodiments are used to implement an early-warning collision detection mechanism. When a GPS in a car recognizes that the car is approaching a pedestrian crossing, the transport system can use the GPS to obtain the coordinates for the crossing, which could be used to do a lookup for a process runtime agent at that location for a pedestrian sensor, thus warn the driver about the existence of potential risks. This could also be combined with automatic security systems in the car making the car slow down to avoid accidents. In this example, the process runtime agent could for example be embedded in a lamp post with sensors to detect nearby pedestrians. Note that software process running in the lamp post could run remotely in a datacenter, but still be associated with a geographical position of the pedestrian or the lamp post.

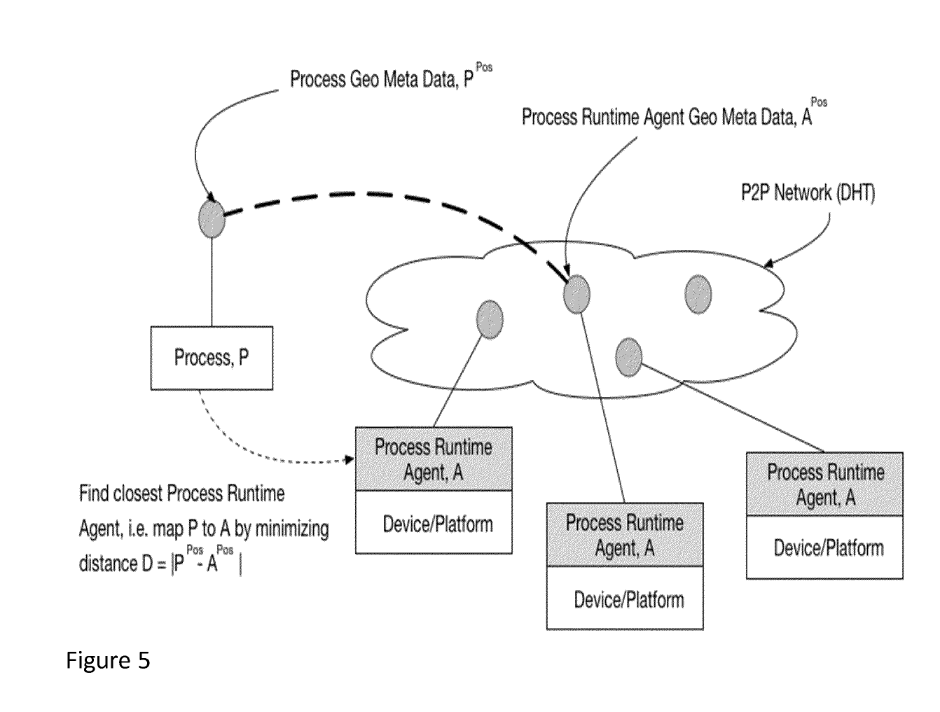

An example is described in conjunction with FIG. 5 to further explain the embodiments of the invention. As mentioned above, the process runtime agent can be connected to underlying cloud platforms, e.g. Mesos, Docker to deploy processes/containers. The process runtime agents of the present invention can also be associated with processes running in end-user devices or IoT devices, e.g. a web server running in an IoT device.

Typically, processes or containers are tagged with a geohash and deployed to any available process runtime agent found in the DHT within the same geohash. A process runtime agent receives the request and then uses the proposed search algorithm to more find a more suitable process runtime agent(s) registered in the DHT network (if it is not the closest already), and then dispatch the process/container to that process runtime agent. Alternatively, an external client can be used to search the DHT and then deploy the container directly to the selected process runtime agent found by the client. An external client could be a Graphical User Interface (GUI) and could be a client program on an OS (Operating System) that gives the possibility to choose where you want to deploy a certain application.

The pre requisites are: Each process runtime agent A publishes its geo meta data in a DHT, i.e. dht.set(geodata^{A}, config), where the config contains meta information how to connect (e.g. IP address) to that process runtime agent. The key, geodata^{A}, is a geohash string representing the geogrid the process runtime agent A belongs to. The geohash string of the geodata key can be pruned to a specific length corresponding to the desired precision specified by the system. The exact geohash location is saved in the config value to be able to do secondary selections, e.g. filter on process types.

Let P^{Pos} be the geohash position of a specific process, P, and A^{Pos} the geohash position of a specific process runtime agent, A, then D is the distance between P^{Pos} and A^{Pos}.

The process requests a process runtime agent (any process runtime agent can be selected) to return the process runtime agent, A, that is closest to P.
1. Find a process runtime agent within the geohash grid of P, referred to as grid layer 0, i.e. P^{Pos}, i.e. where the user wants to run the process. A=dht.get(P^{Pos}), where P^{Pos} is the calculated geohash grid.
2. If A is valid i.e. if a process runtime agent is found in the DHT within the geohash grid of P, return A.
3. If A is not valid, i.e. if a process runtime agent is not found in the DHT within the geohash grid of P, select the next grid layer (grid layer=grid layer+1), by using an expand search described below.
4. The expand search is used to find an array of geohash blocks, B in the current grid layer (e.g. grid layer 1).
   a. For each block, i, in B, look for possible process runtime agents As, i.e. A=dht.get(B[i]).
      i. If A is valid, then store A in a selection array, S.
   b. In S find and return the closest Process Runtime Agent where the distance, D, between in P^{Pos} and S[i] is shortest, alternatively return the whole selection array for a secondary filtering taking into account processing load, network latency, memory, machine types, service type (e.g. different type of equipment such as kitchen equipment for IoT devices.).
5. If no A is found, go to the next grid layer (grid layer++), and go to Step 4 to search in an increased geographical area.

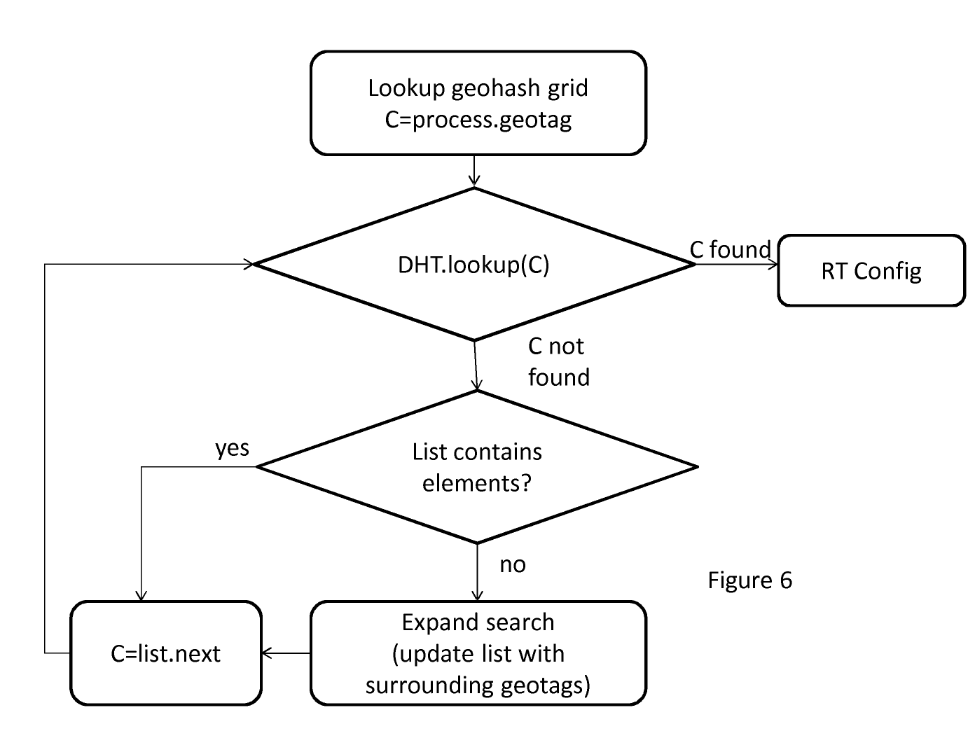

FIG. 6 shows a flowchart of the proposed algorithm. The algorithm of the requested process runtime agent starts by looking up the geohash grid of the process that is going to be found or deployed, and check if there is any process runtime agents stored under that geohash grid key in the DHT, i.e. located within the same geohash grid as the process. If no process runtime agents are found as values in the DHT, the search will be extended to the surrounding geohash grids, which in turn will be searched in the DHT. This procedure is then repeated until a process runtime agent is found, when an RT config is obtained. Then it is possible to connect to a process runtime agent. The RT config may contain IP-number/port which makes it possible to connect to the process runtime agent and in this way connect to the processes running on that process running agent.

Typically, process runtime agents are unlikely to be found directly in grid layer 0 (Step 1), which means that the search area for a process runtime agents need to be extended, i.e. the grid layer needs to be increased, and Step 4 in the aforementioned algorithm needs to be repeated. This procedure to extend the search area is referred to as an expand search and allows an extended geographical area to be scanned for process runtime agents A. Possible process runtime agent candidates may be stored in a selection array, or information associated with the process runtime agent candidates. The selection array is associated with the search algorithm described above.

The process runtime agents, or information thereof, in the selection array, S, can then be compared with each other to find the process runtime agent that is close or closest to the process P (Step 4b). Alternatively an ordered list of the multiple process runtime agents found in the selection array can be returned.

This could be useful for performing a secondary selection on the process runtime agents stored in the selection array, implying that the process runtime agents stored in the selection array could be subjected to a filtering. For example, finding the process runtime agent that is least loaded (e.g. have least CPU load), or other kinds of attributes as mentioned above.

Note that the proposed solution works both on a virtual and physical infrastructure, that is, search for references to process runtime agents running in a datacenter, or search for references to process runtime agents running on a physical infrastructure or end-users/IoT devices.

The search area for searching for the process runtime agents can be extended in different ways. According to one embodiment a method referred to as LayerExpand is used.

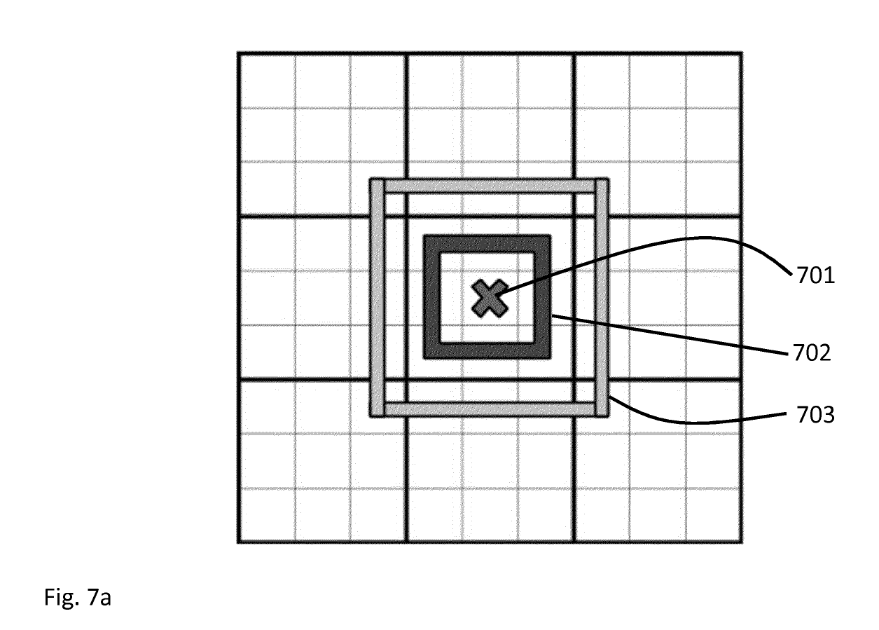

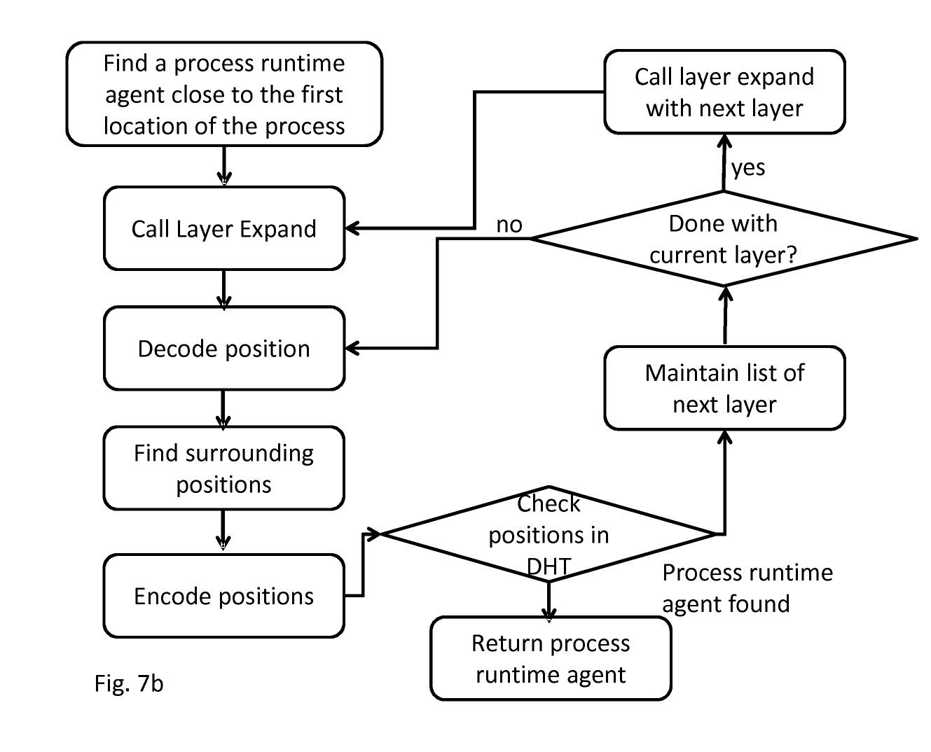

LayerExpand is a search approach that could be explained as rings on the water. The geographical grids surrounding the first geographical location is iteratively extended by starting in the center 701 and for each step recursively check a next layer 702,703 on the outskirts of the area of the previous geographical grids as illustrated by the picture FIG. 7a.

This method returns the values in an ordered matter where the first value is the initial geohash that was provided followed by the values at index 1-8 702 being the first layer and 9-24 703 being the second layer and so on. In this example index 0 being the center, while index 1-8 indicates the first layer and index 9-24 indicates the second layer. This makes implementing a “Find N” function quite simple, which basically is looking if the geogrids contains any process runtime agents (until N process runtime agents are found) and saving them in a list while doing the LayerExpand as illustrated in FIG. 7b.

It should be mentioned that some agents which are closer can be missed because when N agents are found the method will terminate and return the list of agents but the agents missed will not be closer than around 20 km (geohash precision 4) compared to the other agents found in that layer. The reasoning around this was to be able to instantly return when N agents were found which would minimize the lookup calls to the DHT. This could be modified to always return all the values in the layer that hit N values, which would mean that all the closest values would always be returned.

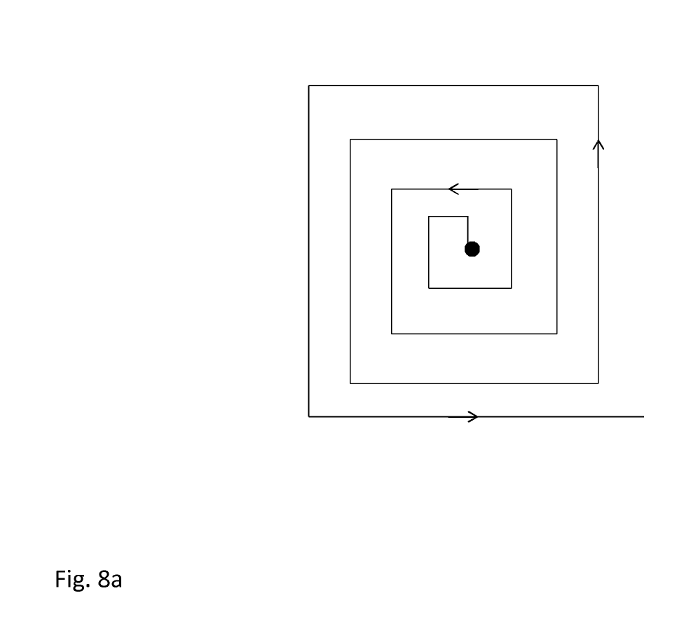

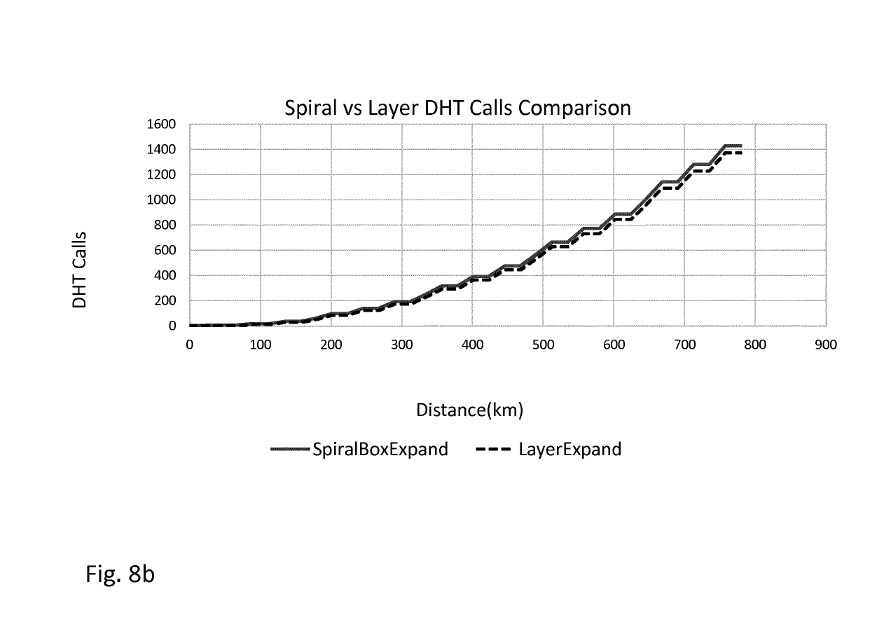

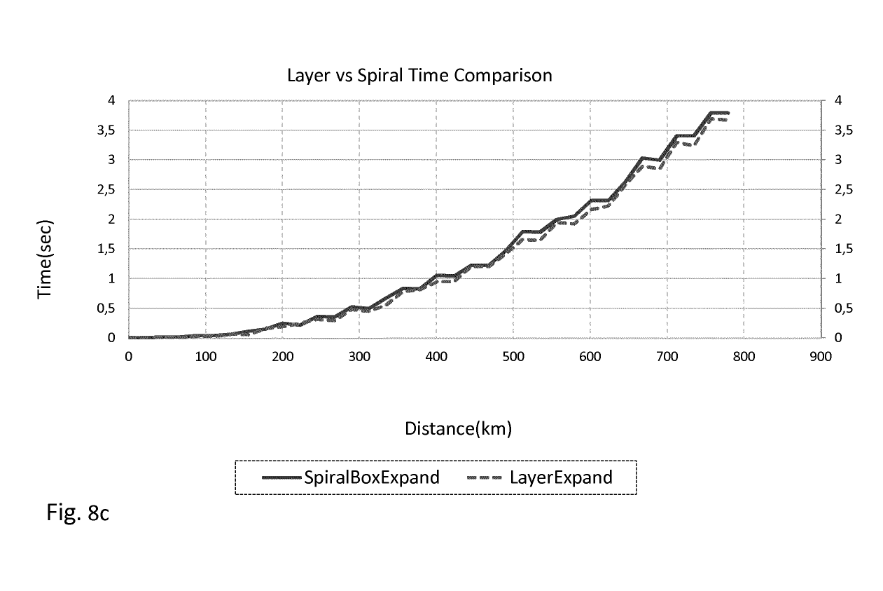

According to a further embodiment, referred to as SpiralBoxExpand, the geographical grids surrounding the first geographical location are iteratively extended in a spiral formed pattern. Hence, SpiralBoxExpand is a search method, which involves checking in an expanding spiral pattern around the center, this implementation is a counter-clockwise spiral and FIG. 8 shows how it on odd values walks north followed by west and on even values walks south and east. It should be noted that it is possible to also implement it as a clockwise spiral.

This method gives a minimal amount of calls to the DHT lookup function in order to find N process runtime agents since as soon as it finds N agents the function will terminate. SpiralBoxExpand has the same problem which was pointed out with the LayerExpand where it can exit before a full layer have been searched resulting in that some process runtime agents will be missed which could be up to 20 km closer. This is due to the same reasoning as for the LayerExpand function.

Compared to the LayerExpand method, SpiralBoxExpand does not require a list of already visited grids to be maintained because it will never visit the same geohash grid twice, this makes it use less memory runtime compared to LayerExpand but it also avoids doing unnecessarily geohash fetches that would have been discarded because they already have been searched like in the other solution. As in LayerExpand this can also be modified to ensure always giving the closest process runtime agent by making sure that the entire layers always will be searched.

This is a comparison of SpiralBoxExpand and the LayerExpand functions in how they perform when it comes to how much they tax the DHT system over different distances and how they do their internal lookups in order to find the geogrid blocks that is searched for Process Runtime Agent meta data to use in the DHT lookup.

This can be seen in SpiralBoxExpand vs LayerExpand DHT calls comparison graph FIG. 8b, where it is shown that both solutions follow each other quite close with slightly higher amount of calls for the spiralbox function. The same pattern can be seen in the distance vs time comparison graph FIG. 8c for the two.

Accordingly, the embodiments describe an iterative search algorithm and a description how to implement the embodiments in different ways to expand searches around the area of a node running a process to locate process runtime agents close to the node by, either deploying a new process or find an existing one.

As mentioned before, the embodiments of the present invention have many applications. For example, they can be used to deploy a video conference server or other time-critical real time systems (running in containers) geographically close to the end-users.

Another use case is Augmented Reality (AR), where an application needs to be responsive and give information about an object a user is looking at. This could be done by letting a building or an object that the user wants to get augmented reality information about have the information stored in their own process runtime agent, wherein the process runtime agent can be found by a user device (in this case the user device is the node on which the process is running), e.g. a phone or AR device, by looking for process runtime agents within a certain radius around the user to give extra information about the surroundings this might even make the user notice something they otherwise would have missed. Additionally, in an IoT (Internet of Things) use cases such as an intelligent transport system, a connected car could ask a crosswalk IoT device (e.g. a lamppost) for possible hazards, e.g. ask if there is any pedestrians close by, the crosswalk IoT device responds to the driver who has access to an advance warning system that can take appropriate actions to the situation.

As mentioned above, an example of an IoT device could be a lamppost. As an example, the node running the process is located in the car and the closest process runtime agent in a lamppost is found by using embodiments of the invention. The process runtime agent could run a software container and thus provide information about pedestrians via connected sensors. The process runtime agent of the lamppost could either run a process locally on container running on an embedded computer, or the process runtime agent of the lamppost could run in a datacenter somewhere. As more devices and services becomes connected, the lines between physical and virtual will be become more blurred, at a point where one could view physical objects such as a car or a building as a complex system of interconnected processes forming a sphere of geo-process taking place in a meta world, layered on top of our real world.

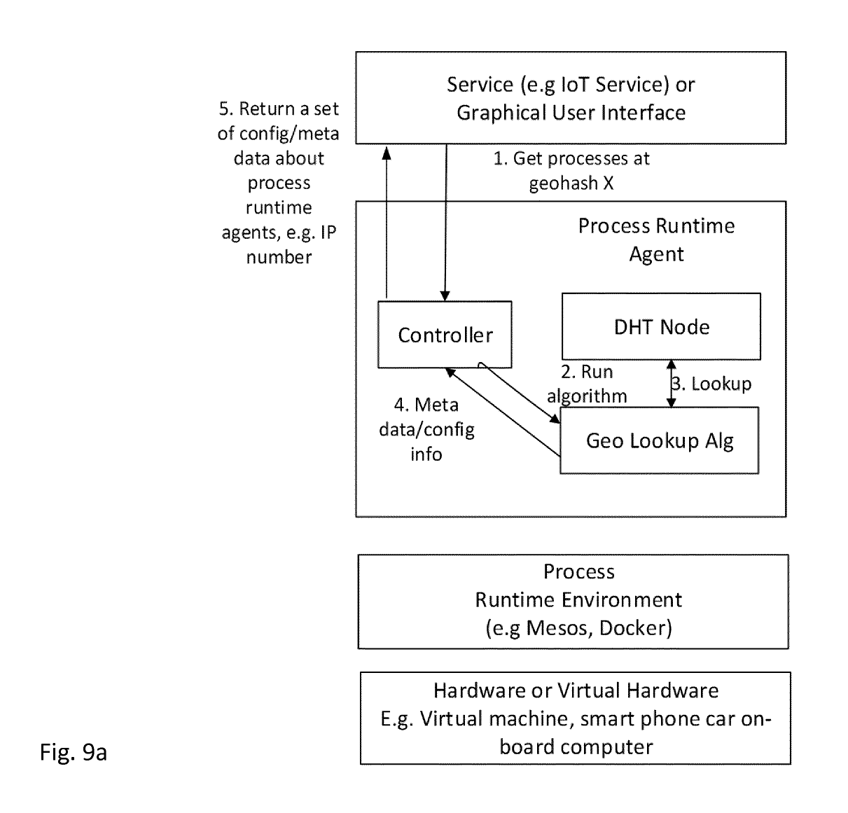

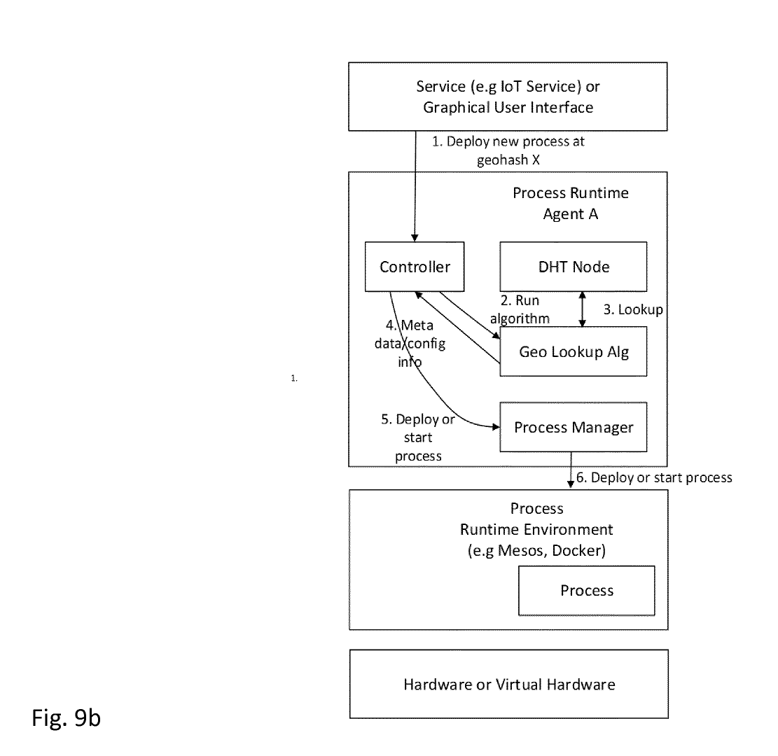

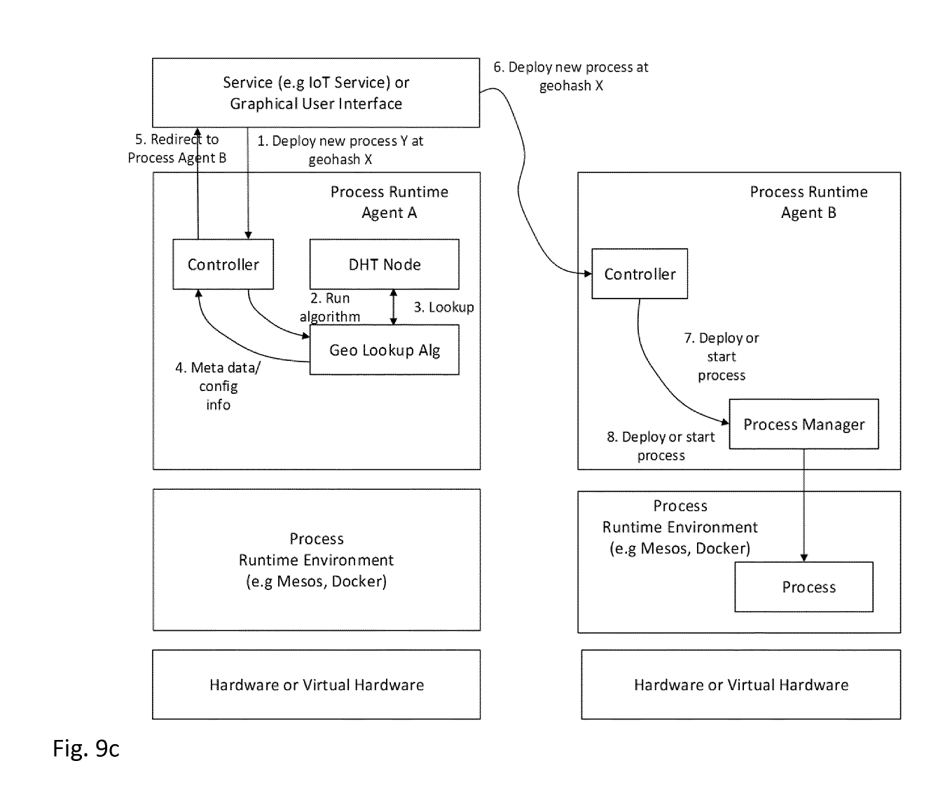

Different cases of the embodiments are further described in conjunction with FIGS. 9a-9c. A process runtime agent is shown comprising a DHT node, a controller, a geo lookup algorithm and a process manager. The process runtime agent is run on a process runtime environment such as Mesos or Docker and the process runtime environment is implemented on hardware or virtual hardware. When a process runtime agent is started, it publishes its geohash information. A virtual hardware platform is a collection of computing resources allocated from a physical host server to a virtual machine (VM) during the virtualization process.

In FIG. 9a, it is shown that the process P (referred to as Service or IoT service in FIG. 9a) requests the process runtime agent to return a set of configuration/meta data of the process runtime agent, A, on a given geohash grid X, wherein X is surrounding the location of process P.

As in FIG. 9a, it is also shown in FIG. 9b, that the process P (referred to as Service or IoT service in FIG. 9a) requests the process runtime agent to return a set of configuration/meta data of the process runtime agent, A, on a given geohash grid X, wherein X is surrounding the location of process P. However, in FIG. 9b, the requested process runtime agent is also selected as the closest runtime agent by the geohash algorithm as described above. As illustrated in FIG. 9c another process runtime agent B is selected by the geohash grid as the closest process runtime agent.

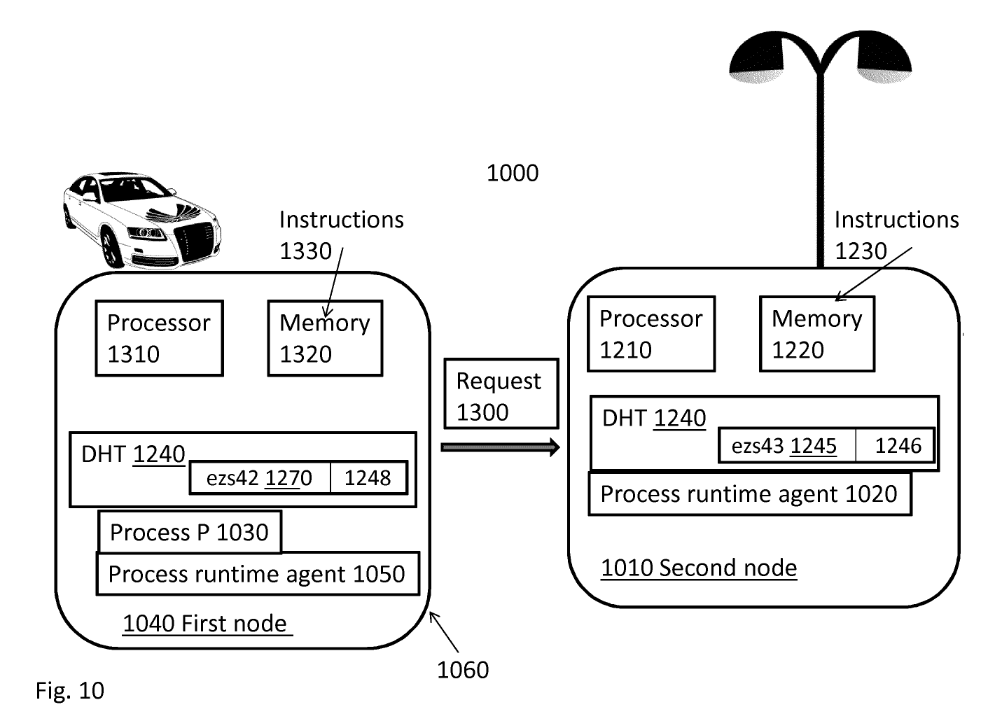

With reference to FIG. 10, a communication network 1000 is illustrated wherein the embodiments may be implemented. The communication network 1000 comprises a second node 1010, associated with a second process runtime agent 1020, and a first node 1040, associated with a first process runtime agent 1050, wherein a process P 1030 is running on the first node 1040 in a first geographical location 1060. The first geographical location 1060 is identified by a geohash string.

The first node 1040 comprises a processor 1310 and a memory 1320 storing instructions 1330 that, when executed by the processor, causes the first node 1040 to send a request 1300 of information of at least one process runtime agent geographically close to the first geographical location.

A second node 1010, is associated with a second process runtime agent 1020 of a communication network 1000. Further, a process P 1030 is running on a first node 1040 associated with a first process runtime agent 1050 in a first geographical location 1060. The first geographical location 1060 is identified by a geohash string and the second node 1010 comprises a processor 1210 and a memory 1220 storing instructions 1230 that, when executed by the processor 1210, causes the second node 1010 to receive a request 1300 of information of at least one process runtime agent geographically close to the first geographical location, and enable representation of process runtime agents and their respective geohash 1245 string in a DHT 1240 wherein the geohash string 1245 is indicative of a coordinate pair of latitude and longitude of the process runtime agent and the length of the string depends on the precision of the coordinate pair. The DHT is distributed over multiple geographical locations associated with a respective process runtime agent.

The stored instructions 1230 that, when executed by the processor 1210, further causes the second node 1010 to initiate a search for process runtime agents in geographical grids surrounding the first geographical location 1060, using the DHT and the geohash strings, to identify a process runtime agent that is geographically close to the first geographical location 1060.

According to an embodiment a key/value pair of the DHT comprises the geohash string 1245 representing the geographical location of the process runtime agent as the key and identity information 1246 of the process runtime agent as the value of the DHT.

Furthermore, the instructions to cause comprise instructions that, when executed by the processor, may cause the second node to identify a process runtime agent that is geographically closest to the first geographical location.

According to another embodiment, the instructions to cause comprise instructions that, when executed by the processor, may cause the second node to store the identified process runtime agent in a selection array.

The instructions to cause comprise instructions that, when executed by the processor, may also cause the second node to compare process runtime agents stored in the selection array with each other to find the process runtime agent closest to the first geographical location.

Moreover, the instructions to cause comprise instructions that, when executed by the processor, may cause the second node to filter process runtime agents stored in the selection array.

According to embodiments of the present invention, the instructions to cause comprise instructions that, when executed by the processor, may cause the second node to iteratively extend the geographical grids surrounding the first geographical location by starting in the center and for each step recursively check a next layer on the outskirts of the area of the previous geographical grids or to iteratively extend the geographical grids surrounding the first geographical location in a spiral formed pattern.

The first node and the second node may comprise input/output unit, respectively for sending and receiving the request 1300.

Turning now to FIG. 12 in conjunction with FIG. 10 which schematically illustrating a computer program and a computer program product implementing the embodiments of the present invention. A computer program 91 for identifying a process runtime agent that is geographically close to a first geographical location 1060 is provided. The process P 1030 is running on a first node 1040 associated with a first process runtime agent 1050 in the first geographical location 1060 and wherein the first geographical location (1060) is identified by a geohash string 1245. The computer program comprising computer program code which, when run on a second node 1010 associated with a second process runtime agent 1020, of a communication network 1000, causes the second node 1010 to:
receive a request 1300 of information of at least one process runtime agent geographically close to the first geographical location,
enable representation of process runtime agents and their respective geohash string in a DHT 1240 wherein the geohash string (1245) is indicative of a coordinate pair of latitude and longitude of the process runtime agent and the length of the string depends on the precision of the coordinate pair, and wherein the DHT is distributed over multiple geographical locations associated with a respective process runtime agent, and
initiate a search for process runtime agents in geographical grids surrounding the first geographical location 1060, using the DHT and the geohash strings, to identify a process runtime agent that is geographically close to the first geographical location 1060.

The computer program product 90 may comprise a computer program according to the description above and a computer readable means on which the computer program is stored.

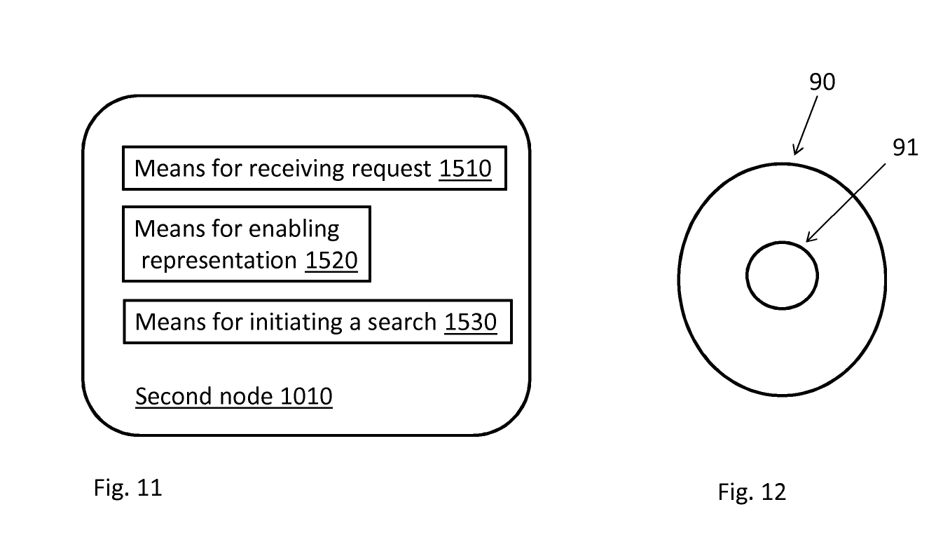

According to a yet further aspect of embodiments of the present invention an implementation of the second node 1010 is schematically illustrated in FIG. 11 in conjunction with FIG. 10. The second node 1010 is associated with a second process runtime agent 1020, of a communication network 1000 (as illustrated in FIG. 10). A process P 1030 is running on a first node 1040 associated with a first process runtime agent 1050 in a first geographical location 1060 and wherein the first geographical location 1060 is identified by a geohash string 1245, the second node (1010) comprising:

Means for receiving (1510) a request of information of at least one process runtime agent geographically close to the first geographical location,

Means for enabling (1520) representation of process runtime agents and their respective geohash string in a distributed hash table, DHT, (1240) wherein the geohash string (1245) is indicative of a coordinate pair of latitude and longitude of the process runtime agent and the length of the string depends on the precision of the coordinate pair, and wherein the DHT is distributed over multiple geographical locations associated with a respective process runtime agent, and

Means for initiating (1530) a search for process runtime agents in geographical grids surrounding the first geographical location (1060), using the DHT and the geohash strings, to identify a process runtime agent that is geographically close to the first geographical location (1060).

According to an embodiment a key/value pair of the DHT comprises the geohash string 1245;1270 representing the geographical location of the process runtime agent as the key and identity information 1246;1248 of the process runtime agent as the value of the DHT.

1-20. (canceled)

21. A method performed in a communication network, wherein a process P is running on a first node associated with a first process runtime agent in a first geographical location, and wherein the first geographical location is identified by a geohash string, the method comprising:
receiving, by a second node associated with a second process runtime agent, a request for information of at least one process runtime agent geographically close to the first geographical location;
enabling, by the second node, representation of process runtime agents and their respective geohash string in a distributed hash table (DHT), wherein the geohash string is indicative of a coordinate pair of latitude and longitude of the process runtime agent and the length of the string depends on the precision of the coordinate pair, and wherein the DHT is distributed over multiple geographical locations associated with a respective process runtime agent; and
initiating, by the second node, a search for process runtime agents in geographical grids surrounding the first geographical location, using the DHT and the geohash strings, to identify a process runtime agent that is geographically close to the first geographical location.

22. The method of claim 21, wherein a key/value pair of the DHT comprises the geohash string representing the geographical location of the process runtime agent as the key and identity information of the process runtime agent as the value of the DHT.

23. The method of claim 21, wherein a process runtime agent is identified that is geographically closest to the first geographical location.

24. The method of claim 21, wherein the identified process runtime agent is stored in a selection array.

25. The method of claim 24, wherein process runtime agents stored in the selection array are compared with each other to find the process runtime agent closest to the first geographical location.

26. The method of claim 24, wherein process runtime agents stored in the selection array are subjected to a filtering.

27. The method of claim 21, wherein the geographical grids surrounding the first geographical location are iteratively extended by starting in the center, and for each iteration recursively checking a next layer on the outskirts of the area of the previous geographical grids.

28. The method of claim 21, wherein the geographical grids surrounding the first geographical location are iteratively extended in a spiral formed pattern.

29. A second node, associated with a second process runtime agent, of a communication network, wherein a process P is running on a first node associated with a first process runtime agent in a first geographical location, and wherein the first geographical location is identified by a geohash string, the second node comprising:
processing circuitry;
memory containing instructions executable by the processing circuitry whereby the second node is operative to:
receive a request of information of at least one process runtime agent geographically close to the first geographical location;
enable representation of process runtime agents and their respective geohash string in a distributed hash table (DHT), wherein the geohash string is indicative of a coordinate pair of latitude and longitude of the process runtime agent and the length of the string depends on the precision of the coordinate pair, and wherein the DHT is distributed over multiple geographical locations associated with a respective process runtime agent; and
initiate a search for process runtime agents in geographical grids surrounding the first geographical location, using the DHT and the geohash strings, to identify a process runtime agent that is geographically close to the first geographical location.

30. The second node of claim 29, wherein a key/value pair of the DHT comprises the geohash string representing the geographical location of the process runtime agent as the key and identity information of the process runtime agent as the value of the DHT.

31. The second node of claim 29, wherein the instructions are such that the second node is operative to identify a process runtime agent that is geographically closest to the first geographical location.

32. The second node of claim 29, wherein the instructions are such that the second node is operative to store the identified process runtime agent in a selection array.

33. The second node of claim 32, wherein the instructions are such that the second node is operative to compare process runtime agents stored in the selection array with each other to find the process runtime agent closest to the first geographical location.

34. The second node of claim 32, wherein the instructions are such that the second node is operative to filter process runtime agents stored in the selection array.

35. The second node of claim 29, wherein the instructions are such that the second node is operative to:
iteratively extend the geographical grids surrounding the first geographical location by starting in the center; and
for each iteration, recursively check a next layer on the outskirts of the area of the previous geographical grids.

36. The second node of claim 29, wherein the instructions are such that the second node is operative to iteratively extend the geographical grids surrounding the first geographical location in a spiral formed pattern.

37. A communication network:
a first node associated with a first process runtime agent, wherein a process P is running on the first node in a first geographical location and wherein the first geographical location is identified by a geohash string;
a second node associated with a second process runtime agent;
wherein the first node comprises:
first processing circuitry;
first memory containing instructions executable by the first processing circuitry whereby the first node is operative to send a request for information of at least one process runtime agent geographically close to the first geographical location;
wherein the second node comprises
second processing circuitry;
second memory containing instructions executable by the second processing circuitry whereby the second node is operative to:
receive a request of information for at least one process runtime agent geographically close to the first geographical location;
enable representation of process runtime agents and their respective geohash string in a distributed hash table (DHT), wherein the geohash string is indicative of a coordinate pair of latitude and longitude of the process runtime agent and the length of the string depends on the precision of the coordinate pair, and wherein the DHT is distributed over multiple geographical locations associated with a respective process runtime agent; and
initiate a search for process runtime agents in geographical grids surrounding the first geographical location, using the DHT and the geohash strings, to identify a process runtime agent that is geographically close to the first geographical location.

38. A non-transitory computer readable recording medium storing a computer program product for identifying a process runtime agent that is geographically close to a first geographical location, wherein a process P is running on a first node associated with a first process runtime agent in the first geographical location, and wherein the first geographical location is identified by a geohash string, the computer program product comprising software instructions which, when run on processing circuitry of a second node associated with a second process runtime agent, of a communication network, causes the second node to:
receive a request of information of at least one process runtime agent geographically close to the first geographical location;
enable representation of process runtime agents and their respective geohash string in a distributed hash table (DHT), wherein the geohash string is indicative of a coordinate pair of latitude and longitude of the process runtime agent and the length of the string depends on the precision of the coordinate pair, and wherein the DHT is distributed over multiple geographical locations associated with a respective process runtime agent; and
initiate a search for process runtime agents in geographical grids surrounding the first geographical location, using the DHT and the geohash strings, to identify a process runtime agent that is geographically close to the first geographical location.
